(19) United States
(12) Patent Application Publication
(10) Pub. No.: US 2007/0199960 A1
(43) Pub. Date: Aug. 30, 2007

(54) Device and set for the dispensing of hair dye

(76) Inventors: Thorsten Blum, Darmstadt (DE); Stefan Hopp, Ingelheim (DE); Sabine Kegel, Darmstadt (DE); Tobias Stahle, Pfungstadt (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/705,618

(22) Filed: Feb. 12, 2007

(30) Foreign Application Priority Data
Feb. 13, 2006 (EP) 06002828.9

(51) Int. Cl. B67D 3/00; F16K 7/04

(52) U.S. Cl. 222/511; 251/7

(57) ABSTRACT

A device (1) comprises a reservoir (2), preferably having a transparent wall (8), for holding a flowable product (3) and a dispensing head (4) for discharging the product (3). The dispensing head (4) is joined to the reservoir (2) via a coupling (5), especially a threaded coupling. Provided on dispensing head (4) is an actuator device (6) for opening and closing the dispensing head (4) as desired in order to dispense product accordingly from a discharge opening (18).

In order to prevent erroneous refilling with product when an empty reservoir (2) is replaced with a full reservoir (2), especially when there is a set of reservoirs (2) having different products (3) for coloring hair, it is proposed that the product (3) be a powdered or granulate hair dye and that the surface of the dispensing head (4) or the actuator device (6) have an information surface (7) that is to be assigned to the product (3). The powder or granulate form thus serves to ensure recognition of the color of the product (3).

### FIELD OF THE INVENTION

The subject of the application relates to the hairdressing area and to a device comprising a reservoir for holding a flowable product and a dispensing head for discharging the product, the dispensing head being joined to the reservoir via a coupling and an actuation device for extracting the product being provided on the dispensing head in order to dispense product accordingly from a discharge opening of the device.

### BACKGROUND OF THE INVENTION

Devices of the described type are known in a wide variety of designs. Moreover, it is also known to load stocks of different products in these devices in order in each case to be able to use a device for dispensing a specific hair color.

The known devices and sets have the disadvantage that just a label indicates the hair dye contained in the reservoir. As a result, if the reservoir is refilled it is possible for a hair dye of a color other than the one desired to be erroneously inserted in a device not provided for it. In this case, it would result in hair coloring of an undesired color, whereupon a relatively great effort would be required to achieve a desired color in order to satisfy the customer.

Thus, there is a need to eliminate this disadvantage.

### SUMMARY OF THE INVENTION

The present invention comprises a powdered or granulate hair dye and the surface of the dispensing head or the actuator device has an information surface that is to be assigned to the product. A plurality of such devices can form a set for different hair coloring results.

The proposed innovation has the advantage that, when an empty reservoir is replaced with a full reservoir or when an empty reservoir is refilled, the dispensing head or the actuator device provided thereon gives information about the hair dye to be dispensed with the dispensing head. In this way, even a mixing of a residue of hair dye in the dispensing head with a different hair dye is simplified via a reliable color classification. The information surface can indicate either the color of the hair dye, the color of the hair coloring result to be achieved, a product name adaptation, or a target color of a color wheel for color mixing.

### DETAILED DESCRIPTION

A powdered or granulate hair dye is used as product. It is free-flowing and as a result can be dosed very precisely. Moreover, it has a dry surface that can related to the information surface. The colored surface of the hair dye, before the addition of peroxide, can thus match the information surface or serve as a classification aid. A granulate has the particular advantage that no annoying dust is generated during the mixing of colors.

It is economical to provide just the surface of the actuator device as the information surface and to design the remainder of the dispensing head in a manner that is the same for all devices. However, an actuator device of the same type could also be implemented on differently designed dispensing heads that indicate a hair color or a color result.

If the reservoir has a transparent wall made of glass or plastic, the color of the product can be recognized. The color can be distinctive, particularly with relatively large product particles in granulate form. The color recognition can be compared with the information surface.

An optimal assignment of dispensing head and product to be refilled is achieved if the information surface has a color that corresponds to the color of the product. This is also an especially good way of preventing product left over in the dispensing head or in the reservoir from a previous filling from unintentionally being mixed with a different color product, which would lead to an incorrect hair color. Alternatively, the information surface could have a color that corresponds to the hair color to be achieved or is to be assigned thereto. Then it would also make sense if a refill container or a filled reservoir that can be connected to the dispensing head as a replacement, e.g., can be screwed onto the dispensing head via a threaded coupling would also have a color that corresponds to the hair color to be produced or is to be assigned thereto. For the sake of better recognizability, the color should be provided over all of the actuator device. The same is true for the case where not the actuator device, but the remainder of the dispensing head body is used as the information surface.

A push button is especially suitable as an actuator device. This allows one-handed operation of the device or the devices of a set for hair coloring.

The invention is described in detail below with reference to figures depicting an exemplary embodiment. The following is shown:

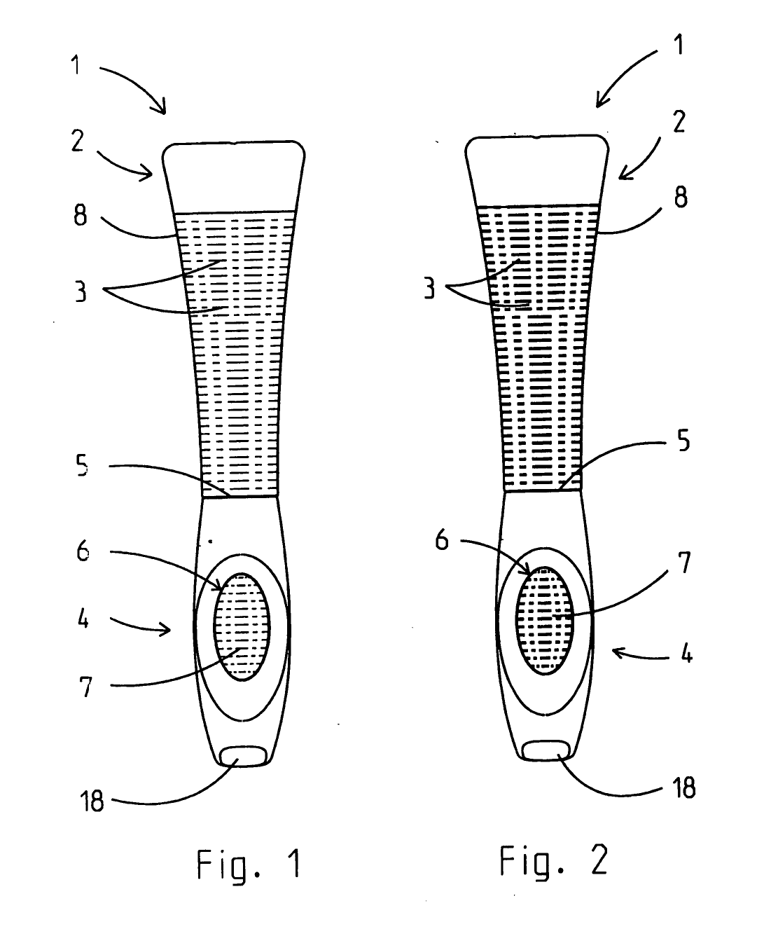

FIG. 1 in a side view, a device having a dispensing head and an actuator device configured as a push button for dispensing free-flowing product for hair coloring that is contained in the form of a granulate in a reservoir of the device, the push button having on its surface a color that corresponds to the hair color, or its tone, to be produced via the granulate to be used;

FIG. 2 in a side view, a device analogous to the one in FIG. 1, but having a granulate for producing a different hair color, i.e., a different tone of a mixture to be achieved and having a push button of a different color;

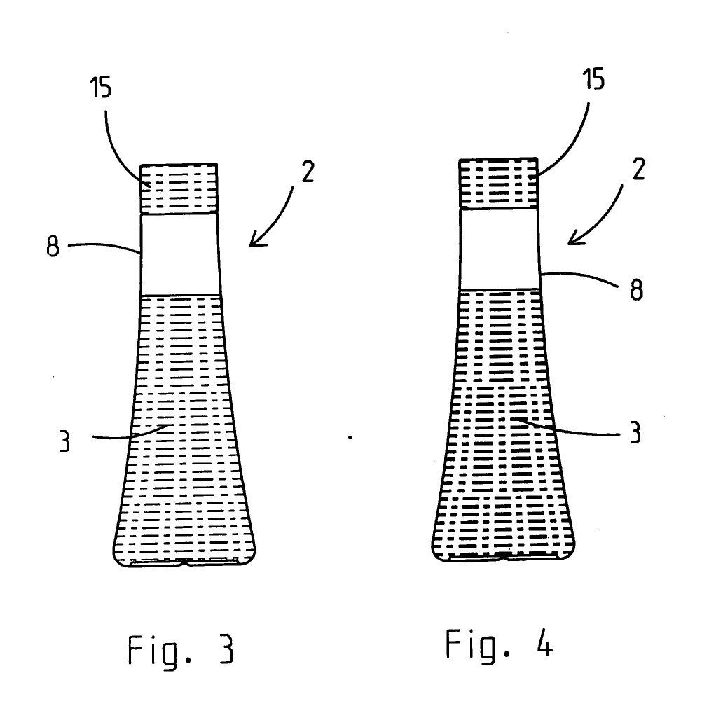

FIG. 3 in a side view, a separate reservoir according to FIG. 1 that is provided with a cap;

FIG. 4 in a side view, a separate reservoir according to FIG. 2 that is provided with a cap;

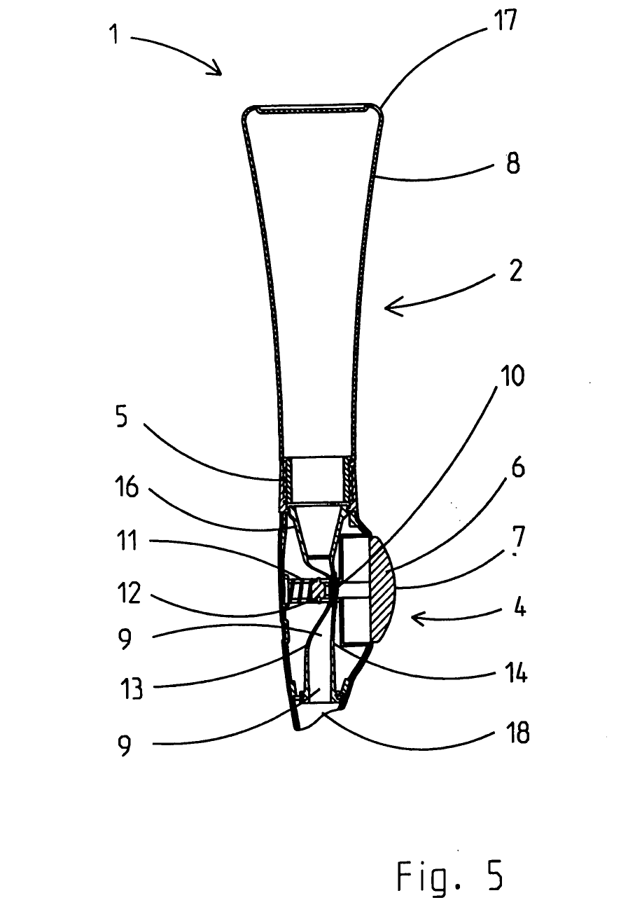

FIG. 5 in a sectional view, the device of FIG. 1 or FIG. 2 where the actuator device is not depressed and a channel that is blocked as a result; and

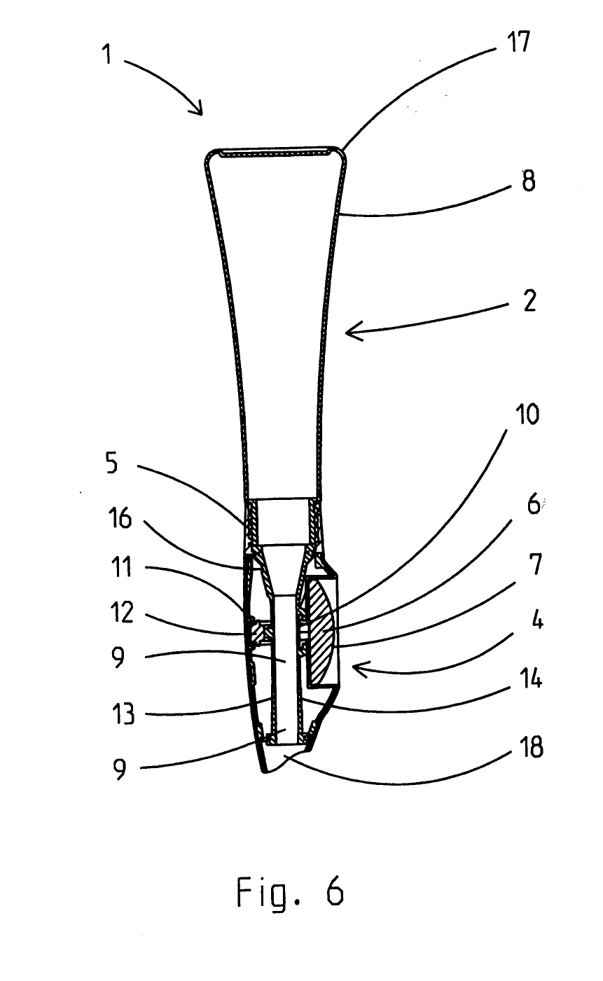

FIG. 6 in a sectional view, the device of FIG. 5, but with the actuator device depressed and as a result the channel open for a dispensing of product.

The device 1 comprises a reservoir 2 having a transparent wall 8 for holding a flowable product 3, and a dispensing head 4 for discharging the product 3 (FIG. 1). The dispensing head 4 is joined to reservoir 2 via a coupling 5 configured as a threaded coupling. Provided on dispensing head 4 is an actuator device 6 in the form of a push button for opening and closing the dispensing head 4 in order to dispense product 3 from a discharge opening 18 of dispensing head 4 when actuator device 6 is pressed. Product 3 is a granulate hair dye. Actuator device 6 has an information surface 7 that is assigned to product 3.

The reservoir 2 comprises a transparent wall 8 made of plastic through which it is possible to recognize single-color product 3. Information surface 7 is configured in a color that corresponds to the pure tone of a later color mixture that is to be produced. The color of product 3 is therefore very similar to the hue to be produced because product 3, as granulate, has a relatively large particle size. Therefore, there is good light reflection on the granulate surfaces, which is important for color recognition. The hue to be produced is provided over the entire surface of actuator device 6. It is a basic color that is used for mixing a target hair color. Taken together this is a set that includes many devices 1. A different basic color is contained in each case in a different device 1. Device 1 of FIG. 2 contains a granulate product 3 in a darker color. Accordingly, information surface 7 of dispensing head 4 indicates the dark hair color that is to be used for mixing.

If a reservoir 2 of device 1 of FIG. 1 is emptied, it can be unscrewed and replaced by a new reservoir 2, whose cap 15 is unscrewed. The same is true for device 1 of FIG. 2 and reservoir 2 of FIG. 4. The color of a closure cap 15 thus corresponds to the color of an accompanying information surface 7 of a corresponding device 1. A hairdresser uses a plurality of devices 1, e.g., eight or twelve or 16 hair colors contained in granulate form for mixing a target hair color. Red, blue, black, etc. hair colors are provided as basic colors.

Dispensing head 4 has a hose-like, deformable channel 9 made of flexible material that is provided to guide the product 3 from the reservoir 2 to the discharge opening 18 (FIG. 5). The dispensing head 4 has a clamping element 12 to enable blocking and releasing of channel 9 as desired. Clamping element 12 is spring loaded in the direction of channel 9 via a spring 11. Actuator device 6 is joined to another clamping element 10 and clamping element 12 in order to pinch off channel 9 (FIG. 5) or, alternatively, make it penetrable for product 3 (FIG. 6) by manual actuation of actuator device 6. Actuator device 6, which is a push button, is rigidly joined to the clamping element 12, which is formed as a surrounding frame. Channel 9 runs through the frame. On one side 13 it rests against the frame. Clamping element 10 rests against the side 14 of channel 9 that is opposite side 13. Spring 11 is provided between clamping element 10 and the frame in order to apply the force that is necessary for clamping when the actuator device is released (FIG. 6).

Device 1 is held with discharge opening 18 facing downward in order to dispense product 3, product 3 flowing from reservoir 2 through a funnel 16 into channel 9. At the end of extended device 1 that is opposite discharge opening 18, a widening 17 of the body is provided for better manual handling of device 1, which can be operated with one hand.

Finally, a hair dye that is mixed together from a plurality of devices 1 is mixed with a peroxide solution and a creme hair coloring that contains no dye in order to produce a reactive hair coloring agent.

1 Device

2 Reservoir

3 Product

4 Dispensing head

5 Coupling

6 Actuator device

7 Information surface

8 Wall

9 Channel

10 Clamping element

11 Spring

12 Clamping element

13, 14 Side

15 Cap

16 Funnel

17 Widening

18 Discharge opening

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A device, comprising a reservoir for holding a flowable product and a dispensing head for dispensing the product, the dispensing head being joined to the reservoir via a coupling, and an actuator device being provided on the dispensing head for the extraction of product in order to dispense product from the discharge opening, wherein the product is a powdered or granulate hair dye and the surface of the dispensing head or the actuator device comprises an information surface that is to be assigned to the product.

2. According to claim 1, wherein the reservoir comprises a transparent wall made of glass or plastic.

3. According to claim 1, wherein the information surface has a color that corresponds to the color of the product.

4. According to claim 1, wherein the information surface comprises a color that corresponds to the hair color to be produced or is to be assigned thereto.

5. According to claim 3, wherein the color is provided over the entire area of the actuator device.

6. According to claim 1, wherein the actuator device is a push button.

7. According to claim 1, wherein the coupling is a threaded coupling.

8. Set, comprising a plurality of devices as described in claim 1, wherein the devices comprise different products for different hair coloring results.
